(19) United States
(12) Patent Application Publication
(10) Pub. No.: US 2026/0288199 A1
(43) Pub. Date: Sep. 24, 2026

(54) HEAD MOUNTED DISPLAY DEVICE

(71) Applicant: HTC Corporation, Taoyuan City (TW)

(72) Inventors: Chun-Kai Yang, Taoyuan City (TW); Yueh Min Huang, Taoyuan City (TW)

(73) Assignee: HTC Corporation, Taoyuan City (TW)

(21) Appl. No.: 19/087,587

(22) Filed: Mar. 24, 2025

(51) Int. Cl. G06F 1/16; F16C 11/04

(52) U.S. Cl. CPC G06F 1/163; F16C 11/045

(57) ABSTRACT

Provided is a head mounted display device, which includes a host, two brackets, two first torque sources and two second torque sources. The two brackets are respectively pivotally connected to opposite sides of the host by a pivoting region. The two first torque sources are respectively disposed between the corresponding bracket and the host, and respectively configured to provide a first torque to drive the corresponding bracket to rotate in a folding direction. The two second torque sources are respectively disposed between the corresponding bracket and the host, and respectively configured to provide a second torque to drive the corresponding bracket to rotate in the folding direction when an angle between the corresponding bracket and the host is less than a critical angle.

### BACKGROUND

### Technical Field

The disclosure is related to a display device, and in particular related to a head mounted display device.

### Related Art

With the increasing development of the technology industry, the forms, functions, and methods of display devices are becoming more diverse, and head mounted display devices that may be directly worn on user's head have emerged in response. There are many types of head mounted display devices. Taking eyeglasses-type head mounted display devices as an example, after users wear such display devices, in addition to seeing perspective images, the images may also change with the rotation of the user's head, which may provide the users with a more immersive experience.

However, everyone's head shape varies in size. Therefore, head mounted display devices need to provide adjustable structures to accommodate different users to enhance wearing comfort, and to avoid the head mounted display devices from falling and being damaged.

### SUMMARY

The disclosure provides a head mounted display device, which provides an adjustable structure to accommodate different users.

The head mounted display device of the disclosure includes a host, two brackets, two first torque sources, and two second torque sources. The two brackets are respectively pivotally connected to opposite sides of the host by a pivoting region. The two first torque sources are respectively disposed between the corresponding bracket and the host, and respectively configured to provide a first torque to drive the corresponding bracket to rotate toward a folding direction. The two second torque sources are respectively disposed between the corresponding bracket and the host, respectively configured to provide a second torque to drive the corresponding bracket to rotate toward the folding direction when an angle between the corresponding bracket and the host is less than a critical angle, and respectively configured to provide a third torque to drive the corresponding bracket to rotate toward an unfolding direction when the angle between the corresponding bracket and the host is greater than the critical angle. The unfolding direction is opposite to the folding direction.

Based on the above, in the head mounted display device of the disclosure, a torque of the second torque source may increase or decrease a clamping force, allowing users with different sizes of head shape to obtain a comfortable wearing experience.

### BRIEF DESCRIPTION OF THE DRAWINGS

FIG. 1 is a perspective schematic view of a head mounted display device according to an embodiment of the invention.

FIG. 2 to FIG. 4 are schematic top views of the head mounted display device in FIG. 1 in three states.

FIG. 5A is a schematic top view of the head mounted display device in FIG. 1 in the three states of FIG. 2 to FIG. 4.

FIG. 5B is a diagram of the relationship between an angle of the bracket of the head mounted display device in FIG. 1 and a torque received.

FIG. 6 is a schematic view of a head mounted display device at a second torque source according to another embodiment of the invention.

FIG. 7 is an exploded schematic view of the second torque source of the head mounted display device in FIG. 6.

FIG. 8 is a schematic view of another state of the second torque source of the head mounted display device in FIG. 6.

FIG. 9 is a schematic view of a head mounted display device at a second torque source according to yet another embodiment of the invention.

FIG. 10 is a schematic view of a head mounted display device at a second torque source according to still another embodiment of the invention.

### DESCRIPTION OF THE EMBODIMENTS

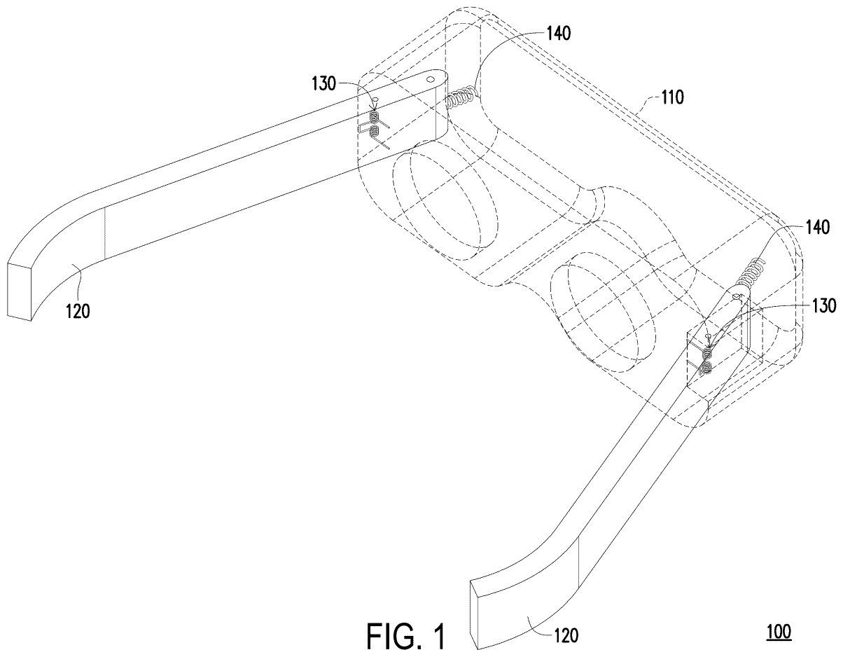

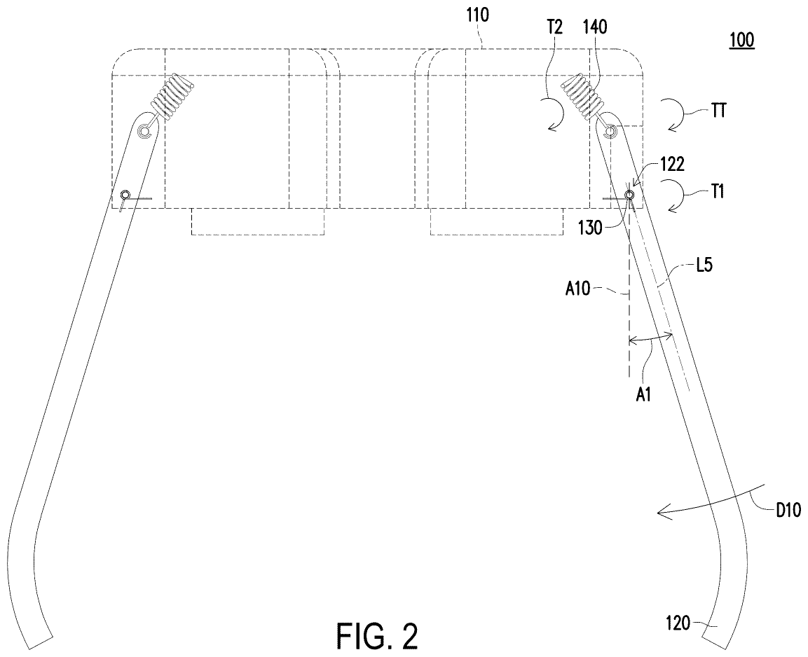

FIG. 1 is a perspective schematic view of a head mounted display device according to an embodiment of the invention. FIG. 2 to FIG. 4 are schematic top views of the head mounted display device in FIG. 1 in three states. Please refer to FIG. 1 and FIG. 2. A head mounted display device 100 of the embodiment includes a host 110, two brackets 120, two first torque sources 130, and two second torque sources 140. In the embodiment, the host 110 is a display, which may, for example, be applied in fields such as virtual reality system, augmented reality system, or mixed reality system. The host 110 may include components, such as a display module, an optical system, and a protective housing. The brackets 120 of the embodiment are legs, which are configured to fix the host 110 to the user's head.

In the embodiment, total quantities of the brackets 120, the first torque sources 130, and the second torque sources 140 are all two. Quantities of the brackets 120, the first torque sources 130, and the second torque sources 140 on each side of the host 110 are all one. Here, only the bracket 120, the first torque source 130, and the second torque source 140 on one side of the host 110 are taken for description. The condition on the other side is basically the same, so the descriptions are omitted.

In the embodiment, each bracket 120 is pivotally connected to one side of the host 110 by a pivoting region 122. Each first torque source 130 is disposed between the corresponding bracket 120 and the host 110, and configured to provide a first torque T1 to drive the corresponding bracket 120 to rotate toward a folding direction D10. Each second torque source 140 is disposed between the corresponding bracket 120 and the host 110. The bracket 120 may rotate relative to the host 110, and an angle A1 between the two also changes as the bracket 120 rotates. Specifically, the angle A1 is formed by a length direction L5 of the bracket 120 and an optical axis direction A10 of an optical system of the host 110.

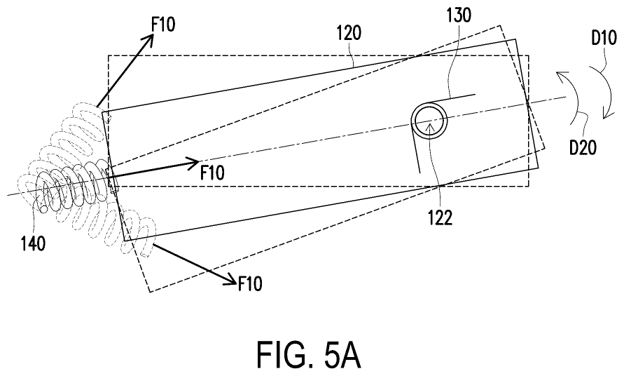

FIG. 5A is a schematic top view of the head mounted display device in FIG. 1 in the three states of FIG. 2 to FIG. 4. FIG. 5B is a diagram of the relationship between an angle of the bracket of the head mounted display device in FIG. 1 and a torque received. Please refer to FIG. 2, FIG. 5A and FIG. 5B. When the angle A1 between the bracket 120 and the host 110 is less than a critical angle, the second torque source 140 provides a second torque T2 to the bracket 120 to drive the bracket 120 to rotate toward the folding direction D10. For example, the second torque source 140 may be a telescopic spring. When the angle A1 between the bracket 120 and the host 110 is less than the critical angle, an elastic force F10 applied by the second torque source 140 to the bracket 120 is kept a distance from the pivoting region 122, so the elastic force F10 may generate the second torque T2 on the bracket 120. When the angle A1 between the bracket 120 and the host 110 is less than the critical angle, it is indicated that a head shape of the user of the head mounted display device 100 is smaller. As shown in FIG. 5B, at this time, the first torque T1 provided by the first torque source 130 may be relatively small, which is insufficient to drive the bracket 120 to securely and stably clamp the head mounted display device 100 on the user's head. However, the second torque T2 provided by the second torque source 140 may supplement the insufficiency of the first torque T1, so both may commonly drive the bracket 120 to securely and stably clamp the head mounted display device 100 on the user's head.

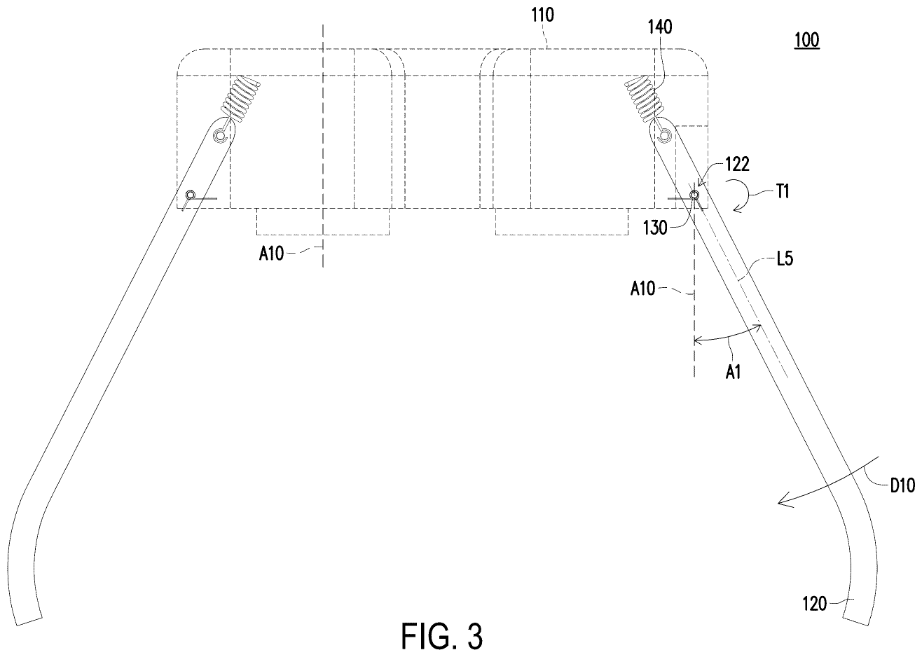

From FIG. 5B, it can be seen that a magnitude of the first torque T1 usually increases as the angle A1 increases. On the other hand, through design, a distance kept between the elastic force F10 applied by the second torque source 140 to the bracket 120 and the pivoting region 122 decreases as the angle A1 approaches the critical angle. Therefore, the second torque T2 also decreases as the angle A1 approaches the critical angle. When the state in FIG. 2 changes toward the state in FIG. 3, a sum of torques TT of the first torque T1 and the second torque T2 that have been designed may be kept fixed, providing a same appropriate clamping force to users with different sizes of head shape.

Please refer to FIG. 3, FIG. 5A and FIG. 5B. When the head mounted display device 100 converts from the state in FIG. 2 to the state in FIG. 3, that is, when the angle A1 equals the critical angle, the second torque T2 provided by the second torque source 140 to the bracket 120 becomes zero. For example, at this time, the elastic force F10 applied by the second torque source 140 to the bracket 120 exactly passes through the pivoting region 122, so an effective torque on the bracket 120 may not be generated.

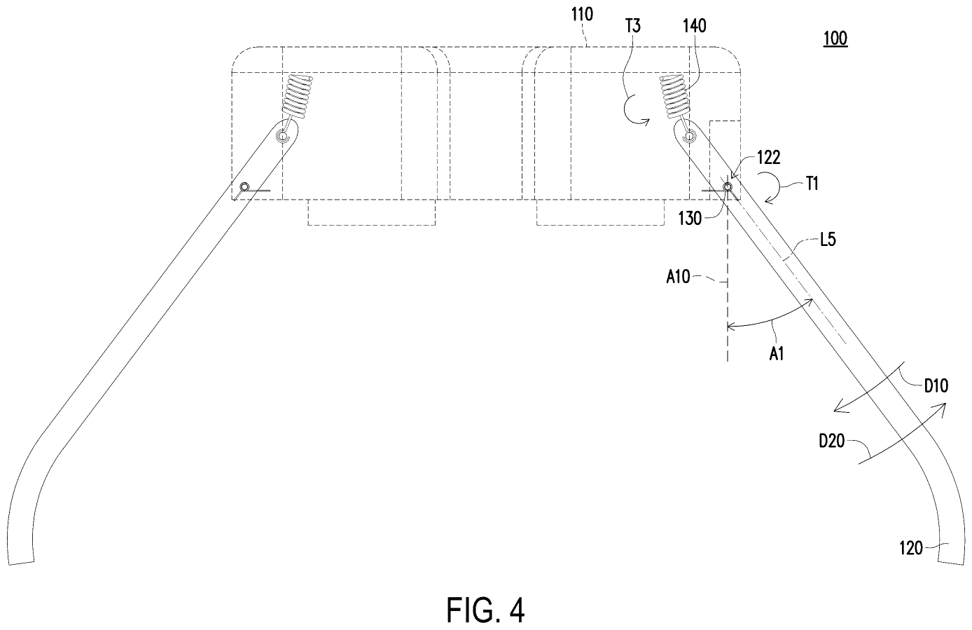

Please refer to FIG. 4, FIG. 5A and FIG. 5B. When the angle A1 between the bracket 120 and the host 110 is greater than the critical angle, the second torque source 140 provides a third torque T3 to the bracket 120 to drive the bracket 120 to rotate toward an unfolding direction D20. The unfolding direction D20 is opposite to the folding direction D10. For example, the second torque source 140 may be a telescopic spring. When the angle A1 between the bracket 120 and the host 110 is greater than the critical angle, the elastic force F10 applied by the second torque source 140 to the bracket 120 is kept a distance from the pivoting region 122, so the elastic force F10 may generate the third torque T3 on the bracket 120. Since the elastic force F10 in FIG. 2 and FIG. 4 respectively passes through different sides of the pivoting region 122, directions of the second torque T2 and the third torque T3 are also opposite. When the angle A1 between the bracket 120 and the host 110 is greater than the critical angle, it is indicated that a head shape of the head mounted display device 100 is larger. As shown in FIG. 5B, at this time, the first torque T1 provided by the first torque source 130 may be relatively large, which might allow the bracket 120 to apply an excessive clamping force on the user's head and cause discomfort for the user. However, the third torque T3 provided by the second torque source 140 may cancel part of the first torque T1, so the bracket 120 may apply an appropriate clamping force on the user's head, and may still securely and stably clamp the head mounted display device 100 on the user's head.

From FIG. 5B, it can be seen that, through design, the distance kept between the elastic force F10 applied by the second torque source 140 to the bracket 120 and the pivoting region 122 gradually increases as the angle A1 approaches from the critical angle, and the third torque T3 also increases accordingly. When the state in FIG. 3 changes toward the state in FIG. 4, the sum of torques TT of the first torque T1 and the third torque T3 that have been designed may be kept fixed, providing a same appropriate clamping force to users with different sizes of head shape. In the embodiment, the critical angle is 10 degrees. In other words, in a state where the bracket 120 is outwardly unfolded to 10 degrees, the torque provided by the second torque source 140 is 0. The critical angle is not limited as 10 degrees by the disclosure, and may also be defined as other angles according to design needs.

Please refer to FIG. 2 again. A connection region between the second torque source 140 and the bracket 120 of the embodiment is not at the pivoting region 122, instead keeping a distance from the pivoting region 122. In this way, the elastic force F10 applied by the second torque source 140 to the bracket 120 may be allowed to generate an effective torque on the bracket 120.

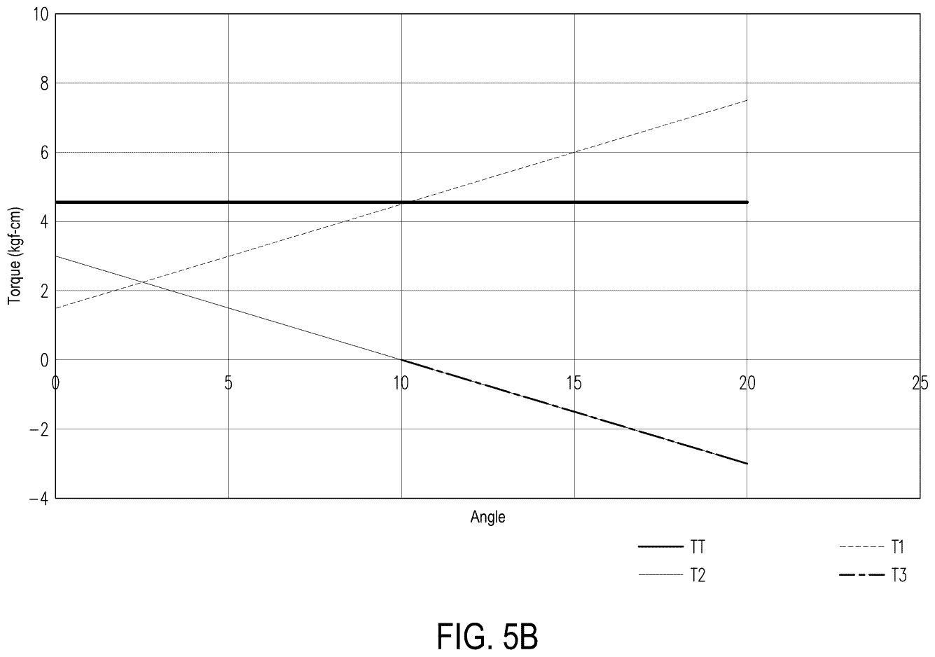

FIG. 6 is a schematic view of a head mounted display device at a second torque source according to another embodiment of the invention. Please refer to FIG. 1 and FIG. 6. The head mounted display device of the embodiment is similar to the head mounted display device 100 in FIG. 1 with only a second torque source 240 being different, so the drawings and descriptions of other parts are omitted. Each second torque source 240 includes a slider 242, a telescopic spring 244, a fixed block 246A and a sliding rod 248. The slider 242 and the telescopic spring 244 are sleeved on the sliding rod 248. The fixed block 246A is fixed to the host 110, so may not rotate with the bracket 120. The sliding rod 248 is fixed to the bracket 120, so may rotate with the bracket 120. The sliding rod 248 passes through the fixed block 246A and may rotate relative to the fixed block 246A. That is, the sliding rod 248 may rotate relative to the host 110 with the bracket 120. The sliding rod 248 synchronously rotates with the slider 242. For example, a shape of an opening in a middle of the slider 242 matches a shape of a cross-section of an upper half section of the sliding rod 248, so the slider 242 may slide on the upper half section of the sliding rod 248 and synchronously rotate with the sliding rod 248.

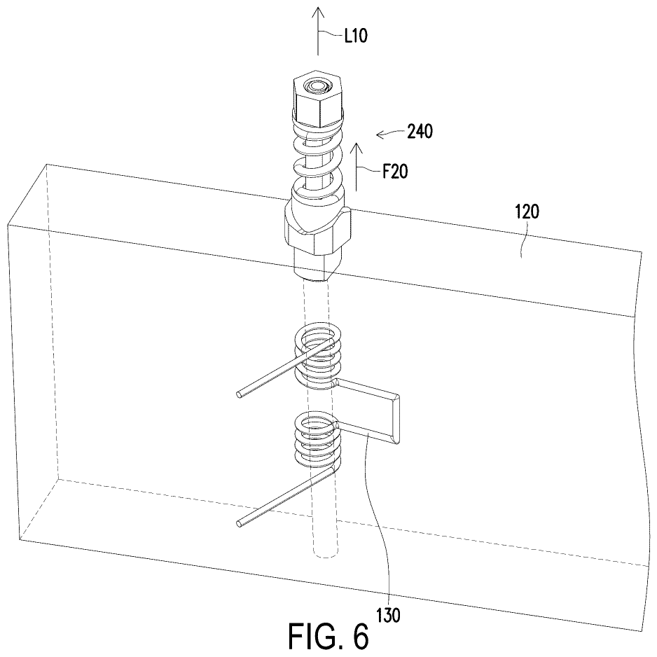

FIG. 7 is an exploded schematic view of the second torque source of the head mounted display device in FIG. 6. Please refer to FIG. 6 and FIG. 7. A length direction L10 of the sliding rod 248 passes through the pivoting region 122 of the bracket 120. That is, the length direction L10 of the sliding rod 248 overlaps with a direction of a rotation axis surrounded by the bracket 120 during rotation. The telescopic spring 244 is abutted against the slider 242. An elastic force applied by the telescopic spring 244 to the slider 242 drives the slider 242 to keep in contact with the fixed block 246A. For example, the second torque source 240 may further include a fixed block 246B. The fixed block 246B is fixed to the host 110, so may not rotate with the bracket 120. The sliding rod 248 passes through the fixed block 246B and may rotate relative to the fixed block 246B. The fixed block 246A and the fixed block 246B are respectively located at both ends of the sliding rod 248. The telescopic spring 244 is limited between the slider 242 and the fixed block 246B. With a sliding of the slider 242, a level of deformation of the telescopic spring 244 is also different, and a magnitude of the elastic force applied by the telescopic spring 244 to the slider 242 may also be different.

When the host and the bracket of the head mounted display device of the embodiment present the state as in FIG. 3, that is, when the angle A1 between the bracket 120 and the host 110 equals to the critical angle, a direction of a reaction force F20 applied by the fixed block 246A to the slider 242 is parallel to the length direction L10. As in the state of FIG. 6, the reaction force F20 of the fixed block 246A may only prevent the slider 242 from sliding in the length direction L10, and there may be no component force in other directions applied to the slider 242 to allow to rotate.

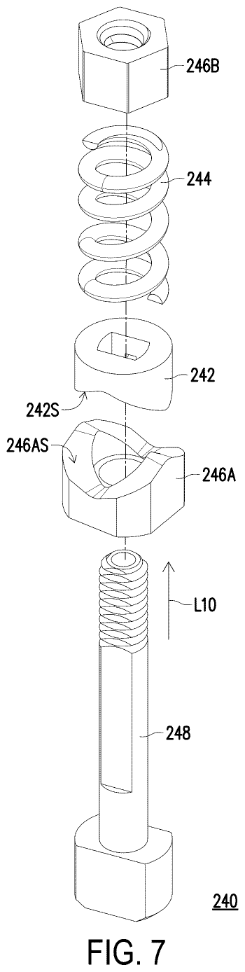

FIG. 8 is a schematic view of another state of the second torque source of the head mounted display device in FIG. 6. Please refer to FIG. 8. When the host and the bracket of the head mounted display device of the embodiment present the state as in FIG. 2, that is, when the angle A1 between the bracket 120 and the host 110 does not equal to the critical angle, the reaction force F20 applied by the fixed block 246A to the slider 242 drives the slider 242 to drive the sliding rod 248 to rotate. Specifically, when the angle A1 between the bracket 120 and the host 110 does not equal to the critical angle, the fixed block 246A and the slider 242 contact each other via an inclined surface, so a direction of the reaction force F20 applied by the fixed block 246A to the slider 242 may not be parallel to the length direction L10. At this time, the reaction force F20 drives the slider 242 to rotate, and the slider 242 drives the sliding rod 248 to rotate. That is, the reaction force F20 applies a torque to the bracket 120. Based on a difference in directions of contact inclined surfaces of the fixed block 246A and the slider 242, a direction of the torque applied by the reaction force F20 to the bracket 120 may also be different, which is similar to conditions in the embodiments of FIG. 2 to FIG. 4.

When a head shape of the user of the head mounted display device of the embodiment is smaller, the direction of the torque applied by the reaction force F20 to the bracket 120 is the same as the first torque T1 provided by the first torque source 130, which may supplement the insufficiency of the first torque T1, so both may commonly drive the bracket 120 to securely and stably clamp the head mounted display device of the embodiment on the user's head.

When a head shape of the user of the head mounted display device of the embodiment is larger, the direction of the torque applied by the reaction force F20 to the bracket 120 is opposite to the first torque T1 provided by the first torque source 130, which may cancel part of the first torque T1, allowing the bracket 120 to apply an appropriate clamping force on the user's head, and may still securely and stably clamp the head mounted display device of the embodiment on the user's head.

In the embodiment, a surface 242S of the slider 242 configured to contact the fixed block 246A and a surface 246AS of the fixed block 246A configured to contact the slider 242 are both wave-shaped annular surfaces.

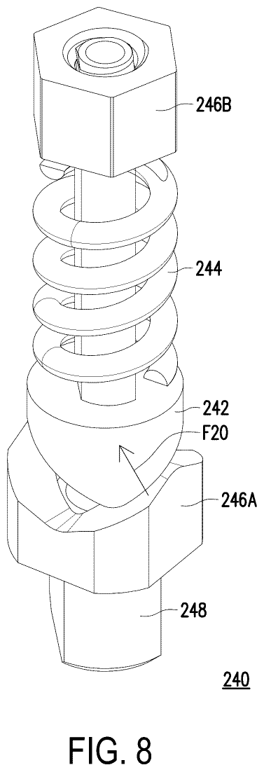

FIG. 9 is a schematic view of a head mounted display device at a second torque source according to yet another embodiment of the invention. Please refer to FIG. 1 and FIG. 9. The head mounted display device of the embodiment is similar to the head mounted display device 100 in FIG. 1 with only a second torque source 340 being different, so the drawings and descriptions of other parts are omitted. In the embodiment, each second torque source 340 includes a slider 342 and a telescopic spring 344. The telescopic spring 344 is abutted against the slider 342. An elastic force applied by the telescopic spring 344 to the slider 342 drives the slider 342 to keep abutted against the corresponding bracket 120. The slider 342 is limited to slide along a sliding direction D30. The sliding direction D30 passes through the pivoting region 122 of the corresponding bracket 120.

When the slider 342 contacts a lower side of the bracket 120 in FIG. 9, that is, when a head shape of the user of the head mounted display device of the embodiment is smaller, a direction of the torque applied by the slider 342 to the bracket 120 is the same as the first torque T1 provided by the first torque source 130, which may supplement the insufficiency of the first torque T1, so both may commonly drive the bracket 120 to securely and stably clamp the head mounted display device of the embodiment on the user's head.

When the slider 342 contacts an upper side of the bracket 120 in FIG. 9, that is, when a head shape of the user of the head mounted display device of the embodiment is larger, the direction of the torque applied by the slider 342 to the bracket 120 is opposite to the first torque T1 provided by the first torque source 130, which may cancel part of the first torque T1, allowing the bracket 120 to apply appropriate clamping force on the user's head, and still securely and stably clamp the head mounted display device of the embodiment on the user's head.

In the embodiment, a surface 342A of the slider 342 configured to contact the bracket 120 and a surface 120A of the bracket 120 configured to contact the slider 342 are both curved surfaces. For example, a channel is configured in the host of the head mounted display device for the slider 342 to slide, which may also limit the sliding direction of the slider 342. Therefore, the effect where when the bracket 120 rotates to different locations, contact positions with the slider 342 also changes accordingly may be generated.

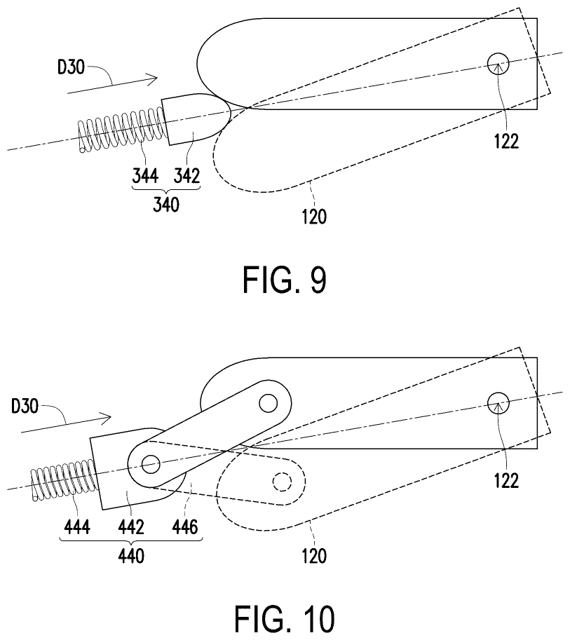

FIG. 10 is a schematic view of a head mounted display device at a second torque source according to still another embodiment of the invention. Please refer to FIG. 1 and FIG. 10. The head mounted display device of the embodiment is similar to the head mounted display device 100 in FIG. 1 with only a second torque source 440 being different, so the drawings and descriptions of other parts are omitted. In the embodiment, each second torque source 440 includes a slider 442, a telescopic spring 444, and a linkage 446. The telescopic spring 444 is connected to the slider 442. The linkage 446 is pivotally connected to the slider 442 and the corresponding bracket 120. A connection region 124 between the linkage 446 and the corresponding bracket 120 keeps a distance from the pivoting region 122. The slider 442 is limited to slide along the sliding direction D30. The sliding direction D30 passes through the pivoting region 122 of the corresponding bracket 120.

When the slider 442 is located on the lower side of the bracket 120 in FIG. 9, that is, when a head shape of the user of the head mounted display device of the embodiment is smaller, a direction of the torque applied by the slider 442 to the bracket 120 through the linkage 446 is the same as the first torque T1 provided by the first torque source 130, which may supplement the insufficiency of the first torque T1, so both may commonly drive the bracket 120 to securely and stably clamp the head mounted display device of the embodiment on the user's head.

When the slider 442 is located on the upper side of the bracket 120 in FIG. 9, that is, when a head shape of the user of the head mounted display device of the embodiment is larger, the direction of the torque applied by the slider 442 to the bracket 120 through the linkage 446 is opposite to the first torque T1 provided by the first torque source 130, which may cancel part of the first torque T1, allowing the bracket 120 to apply an appropriate clamping force on the user's head, and may still securely and stably clamp the head mounted display device of the embodiment on the user's head.

In the embodiment, a channel may be configured in the host of the head mounted display device for the slider 442 to slide, which may also limit the sliding direction of the slider 442. Therefore, the effect where when the bracket 120 rotates to different locations, directions of the torque applied by the slider 442 to the bracket 120 through the linkage 446 also changes accordingly may be generated.

In summary, in the head mounted display device of the disclosure, the second torque source provides different torques according to a difference in angles between the bracket and the host, so the clamping force may be appropriately increased or decreased, allowing users with different sizes of head shape to obtain a comfortable wearing experience.

What is claimed is:

1. A head mounted display device, comprising:
a host;
two brackets, respectively pivotally connected to opposite sides of the host by a pivoting region;
two first torque sources, respectively disposed between the corresponding bracket and the host, and respectively configured to provide a first torque to drive the corresponding bracket to rotate toward a folding direction; and
two second torque sources, respectively disposed between the corresponding bracket and the host, respectively configured to provide a second torque to drive the corresponding bracket to rotate toward the folding direction when an angle between the corresponding bracket and the host is less than a critical angle, and respectively configured to provide a third torque to drive the corresponding bracket to rotate toward an unfolding direction when the angle between the corresponding bracket and the host is greater than the critical angle, wherein the unfolding direction is opposite to the folding direction.

2. The head mounted display device according to claim 1, wherein each of the second torque sources is a telescopic spring, a connection region between each of the second torque sources and the corresponding bracket keeps a distance from the pivoting region, and when the angle of the corresponding bracket equals to the critical angle, an elastic force applied by the second torque source to the corresponding bracket passes through the pivoting region.

3. The head mounted display device according to claim 1, wherein each of the second torque sources comprises a slider and a telescopic spring, the telescopic spring is abutted against the slider, an elastic force applied by the telescopic spring to the slider drives the slider to keep abutted against the corresponding bracket, the slider is limited to slide along a sliding direction, and the sliding direction passes through the pivoting region of the corresponding bracket.

4. The head mounted display device according to claim 3, wherein a surface of each of the sliders configured to contact the corresponding bracket and a surface of each of the brackets configured to contact the corresponding slider are all curved surfaces.

5. The head mounted display device according to claim 1, wherein each of the second torque sources comprises a slider, a telescopic spring and a linkage, the telescopic spring is connected to the slider, the linkage is pivotally connected to the slider and the corresponding bracket, a connection region between the linkage and the corresponding bracket keeps a distance from the pivoting region, the slider is limited to slide along a sliding direction, and the sliding direction passes through the pivoting region of the corresponding bracket.

6. The head mounted display device according to claim 1, wherein each of the second torque sources comprises a slider, a telescopic spring, a fixed block and a sliding rod, the slider and the telescopic spring are sleeved on the sliding rod, the fixed block is fixed to the host, the sliding rod is fixed to the corresponding bracket, the sliding rod passes through the fixed block and may rotate relative to the fixed block, the sliding rod synchronously rotates with the slider, a length direction of the slider passes through the pivoting region of the corresponding bracket, the telescopic spring is abutted against the slider, an elastic force applied by the telescopic spring to the slider drives the slider to keep in contact with the fixed block, when the angle of the corresponding bracket equals to the critical angle, a direction of a reaction force applied by the fixed block to the slider is parallel to the length direction, and when the angle of the corresponding bracket does not equal to the critical angle, the reaction force applied by the fixed block to the slider drives the slider to drive the sliding rod to rotate.

7. The head mounted display device according to claim 6, wherein a surface of each of the sliders configured to contact the corresponding fixed block and a surface of each of the fixed blocks configured to contact the corresponding slider are all wave-shaped annular surfaces.
